(19) United States
(12) Patent Application Publication
(10) Pub. No.: US 2008/0301902 A1
(43) Pub. Date: Dec. 11, 2008

(54) Blower Attachment and Blower Device for Garden and Landscape Maintenance

(76) Inventors: Klaus Willy Gloger, Second Beach (AU); Josef Terbrack, Ahaus (DE)

Correspondence Address: BOHAN MATHERS, PO BOX 17707, PORTLAND, ME, 04112-8707, US

(21) Appl. No.: 11/660,343

(22) PCT Filed: Aug. 15, 2005
(86) PCT No.: PCT/DE05/01444

§ 371 Date: Feb. 14, 2007

(30) Foreign Application Priority Data
Aug. 14, 2004 (DE) 2004 039 499.7
Feb. 1, 2005 (DE) 2005 001 649.7

(51) Int. Cl. A01G 1/12

(52) U.S. Cl. 15/405

(57) ABSTRACT

Blower attachment that attaches to a drive unit having a long driveshaft, such as, for example, a lawn trimmer typically used in garden and landscape maintenance. The blower attachment has a housing and an impeller that rotates therein. When coupled together, the drive shaft drives the impeller in the blower attachment. The rotating impeller causes an intake of air through an inlet in the housing. Air is expelled laterally from the housing through air outlets in the housing, blowing a stream of air horizontally across the ground.

### BACKGROUND INFORMATION

1. Field of the Invention

The innovation relates to the field of motorized blower devices for gardening and landscape maintenance. Such blower devices are used, for example, to blow fallen leaves over the ground and thereby clean the ground of fallen leaves.

2. Description of the Prior Art

Prior-art motorized blower devices have an internal combustion engine and a blower arranged directly adjacent to each another. The operator generally carries such blower devices by its long arm or on his/her back. The expelled air is directed toward the ground through a pipe or hose attached to the blower, so that the generated airflow reaches the material on the ground that is to be blown, such as debris.

In addition, motorized equipment having a long drive shaft are known for use in gardening and landscape maintenance. An example of this type of motorized device is shown schematically in FIG. 1. These motorized devices have a motor that drives a drive shaft that is usually much longer than one meter. Generally, the drive shaft is housed in a tube, in order to eliminate the risk of injury to the user. The aforementioned motorized devices are used, for example, in motorized lawn trimmers. In this case, a cutting tool is coupled to the free end of the drive shaft and rotated by the drive shaft.

Against this backdrop, the object of the present innovation is to offer improved devices for blowing debris in gardening and landscape maintenance. In particular, devices are to be offered that do not exhibit the aforementioned disadvantages. The innovative devices should especially provide an economical blower device that generates less noise and/or transmits fewer vibrations to the user than the prior-art blower devices.

### BRIEF SUMMARY OF THE INVENTION

The invention is a blower attachment for use with a gardening and landscape maintenance drive unit having a long drive shaft. The blower attachment according to the invention comprises a housing and a rotatable impeller therein. The housing has an appropriately arranged inlet for drawing in air and an appropriately arranged outlet for expelling air. The impeller is constructed such that, during rotation, air is drawn through the inlet of the housing and expelled through the outlet of the housing. Furthermore, the blower attachment is coupled to the drive unit in such a way that the impeller is rotated by the rotating drive shaft of the drive unit.

The innovation achieves the desired advantages. Since the blower attachment itself does not contain a motor, it can be manufactured relatively inexpensively, for example, of plastic. The blower attachment according to the invention is couplable to drive units having a long drive shaft, such as are commonly used in gardening and landscape maintenance. Coupling the blower attachment to a conventional drive unit eliminates the costs for a motor that is used only for blowing—and increases the efficient use of existing drive units. In this way, the blower attachment according to the invention affords cost savings. In particular, the blower attachment according to the invention is couplable to a motorized lawn trimmer by means of a drive unit having a long drive shaft. Diverse cutting tools are couplable to a series of such conventional lawn trimmers, and the blower attachment according to the invention can be coupled to such units, instead of the cutting tool.

Furthermore, the innovative blower attachment reduces noise. The motor and blower are not directly adjacent each another, but rather, are separated from each other by the drive shaft, which is generally over one meter long. Thus, the blower does not intensify the noise generated by the motor. Consequently, less noise is produced than with prior-art blower devices.

In a preferred embodiment, the impeller of the blower attachment has an axle or a shaft. Preferably, when coupling the blower attachment to the drive unit, this axle is coupled to the drive shaft. When coupled to the drive unit, the rotation of the drive shaft thus transmits rotation to the impeller via this axle. In another embodiment, however, it is also possible to construct the impeller without this axle, but with a center through-bore for receiving a drive pin or the drive shaft. The manufacture of this blower attachment is especially simple and cost-effective. In this embodiment, the impeller itself is not mounted, until it is screwed onto the drive pin or the drive axle.

According to another preferred embodiment, the impeller is mounted in the housing. If the impeller has an axle, the impeller may be mounted via the mounting of the axle in the housing. This arrangement results in quieter impeller operation. As already discussed, it is also very advantageous with regard to especially cost-effective manufacturing, that the impeller itself does not have a shaft, but rather only a bore or a receptacle for the drive pin or the drive axle.

In another preferred embodiment, the air inlet and air outlet of the housing, as well as the impeller, are constructed such that the air of the impeller rotation is drawn in the axial direction and expelled in the radial direction. In this way, the blower attachment functions as a radial blower. The blower attachment can thus be advantageously constructed such that, after coupling the attachment to the drive unit, the rotational axis of the impeller basically extends perpendicular to the ground during operation. A radial blower attachment constructed in this manner enables air to be drawn from above along the rotational axis of the impeller and then expelled perpendicularly to the rotational axis and thus parallel to the ground. Drawing air from above is advantageous because this prevents debris lying on the ground from being drawn into the blower attachment.

In another preferred embodiment, the housing of the blower attachment has a cover and a base. When using the coupled blower attachment, the base faces the ground and the cover faces away from the ground. The air inlet of the housing, as well as the coupler for coupling to the drive unit, is located in the cover. With regard to the coupling of the blower attachment to the drive unit, however, there are additional advantageous embodiments, which will be described below. Referring again to the air inlets in the cover, this construction also keeps the air inlet as far as possible from the ground debris during use of the blower attachment, which prevents the air inlet from drawing this debris into the blower attachment.

In yet another preferred embodiment, the air inlet in the cover surrounds the coupler annularly. This is achieved, for example, by a ring of air slots around the coupler. This embodiment keeps the air inlet a substantial distance away from the ground. Placing the air inlet in the cover of the housing and close to the rotational axis of the impeller provides the greatest protection against drawing debris into the air inlet.

In yet another preferred embodiment, the impeller is constructed as a disk, on which the impeller blades are essentially arranged standing perpendicular to the plane of the disk and in the form of a ring. This embodiment enables a flat construction of the blower attachment. Preferably, the blower attachment is constructed in such a way that the disk is essentially parallel to the ground when the blower attachment is in use. The disk is suitably located on the side of the impeller facing the housing base. The impeller blades then stand on the side of the disk facing the housing cover. This allows the air to be drawn from above.

In yet another preferred embodiment, the blower attachment is constructed such that, rotation of the impeller causes the air to be drawn on the inside of the blade ring and expelled on the outside of the blade ring. In this way, the air is drawn near the rotational axis of the impeller.

Furthermore, the object according to the present innovation is fulfilled by a blower device that is constructed as a drive unit with a long drive shaft and a blower attachment as previously disclosed. In a blower device according to the invention, the blower attachment is coupled to the drive shaft of the drive unit.

The innovative blower device achieves the desired advantages. The drive unit with the long drive shaft is decouplable from the blower attachment and usable for other purposes in gardening and landscape maintenance. Furthermore, the motor and blower are separated from each other by the long drive shaft on the blower attachment according to the invention, which reduces the noise that is generated. In addition, during use, the motor is separated a distance from the operator, thereby reducing the exposure of the operator to vibrations.

In a preferred embodiment, a drive head to which the blower attachment is coupled is provided on the free end of the drive shaft. Inside the drive head, the rotation of the drive shaft is converted into a rotation, the rotational axis of which is at an angle to the drive shaft. The rotational axis of the impeller of the blower attachment and the drive shaft thus preferably form a blunt angle.

In another preferred embodiment, the drive components of a motorized lawn trimmer are used as the drive unit of the blower device according to the invention. These drive components essentially have the form of a drive unit with a long drive shaft. To construct the blower device according to the invention, the blower attachment is coupled to the drive shaft of the motorized lawn trimmer, in place of the cutting tool. This provides the advantage, that the drive components of a lawn trimmer can also be used for another purpose, namely, for constructing a blower device.

### BRIEF DESCRIPTION OF THE DRAWINGS

The present invention is described with reference to the accompanying drawings. In the drawings, like reference numbers indicate identical or functionally similar elements.

FIG. 1 is a perspective view of a conventional gardening and landscape maintenance power device having a long drive shaft. (Prior Art)

FIG. 2 is an external, perspective view of a blower attachment according to the invention,

FIG. 3 is a cross-sectional view of a blower attachment according to the invention that is attached to a power device.

FIG. 4 is an exploded view of a blower attachment according to the invention.

FIG. 5 is a perspective view of a blower device according to the invention, showing the blower attachment coupled with a drive unit.

FIG. 6 is a cross-sectional view of an embodiment of the blower attachment according to the invention.

FIG. 7 is a cross-sectional view of an embodiment of the blower attachment according to the invention.

FIG. 8 is an exploded view of an embodiment of the blower attachment according to the invention.

FIG. 9 is a cross-sectional view of the embodiment of the blower attachment of FIG. 8.

FIG. 10 is an exploded view of an embodiment of the blower attachment according to the invention.

FIG. 11 is a cross-sectional view of an impeller blade of the blower attachment of FIG. 10.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

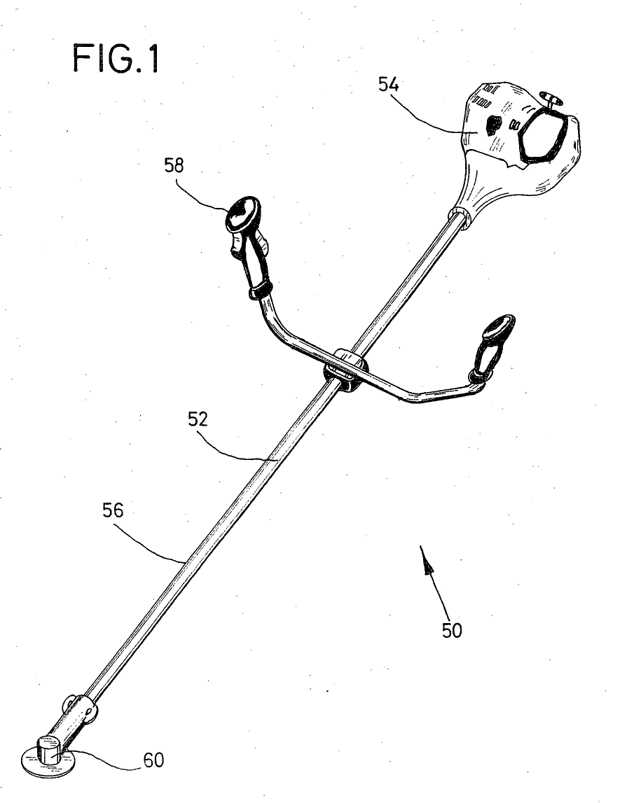

In order to understand the innovation, FIG. 1 shows a conventional gardening and landscape maintenance drive unit 50 with a long drive shaft 52. Such drive units 50 usually have an internal combustion engine or an electric motor 54, which rotates a drive shaft 52, that is typically over one meter long. To prevent injuries to users, the drive shaft is usually sheathed in a stationary protective tube 56. The protective tube 56 prevents the user from coming into direct contact with the rotating drive shaft 52. For greater ease of use, handles 58 may be mounted on the protective tube 56. A drive head 60, which allows a change in the rotational direction, is provided on the free end of the drive shaft 52.

The drive unit shown in FIG. 1 is used especially in motorized lawn trimmers. With such lawn trimmers, the cutting tool, for example, a rotating nylon string or a rotating blade, is attached to the free end of the long drive shaft.

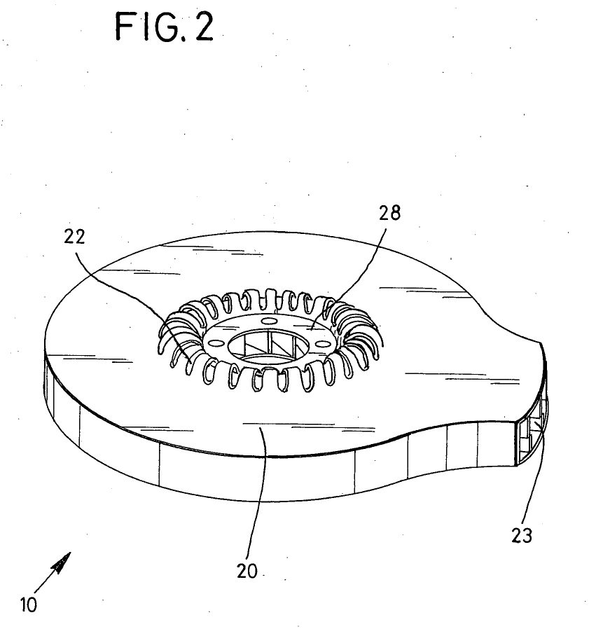

FIG. 2 shows an external view of the innovative blower attachment 10. An inlet 22 for drawing in the blower air is located on the top of the housing 20. The inlet 22 is formed by a ring of air slots surrounding a coupler 28 for coupling the attachment to the drive unit 50. An outlet 23 for expelling the blower air is located on the right side of the housing 20. The arrangement of the inlet 22 and outlet 23 shown in FIG. 2 allows the air to be drawn from above and expelled horizontally across the ground when the blower attachment is used. The close proximity of the inlet 22 to the coupler 28 and, at the same time, the large distance between the inlet 22 and the ground prevents the debris on the ground from being drawn into the inlet. Furthermore, the construction of the inlet 22 as a ring of air slots prevents larger objects from being drawn into the housing, since the air slots act like a sieve.

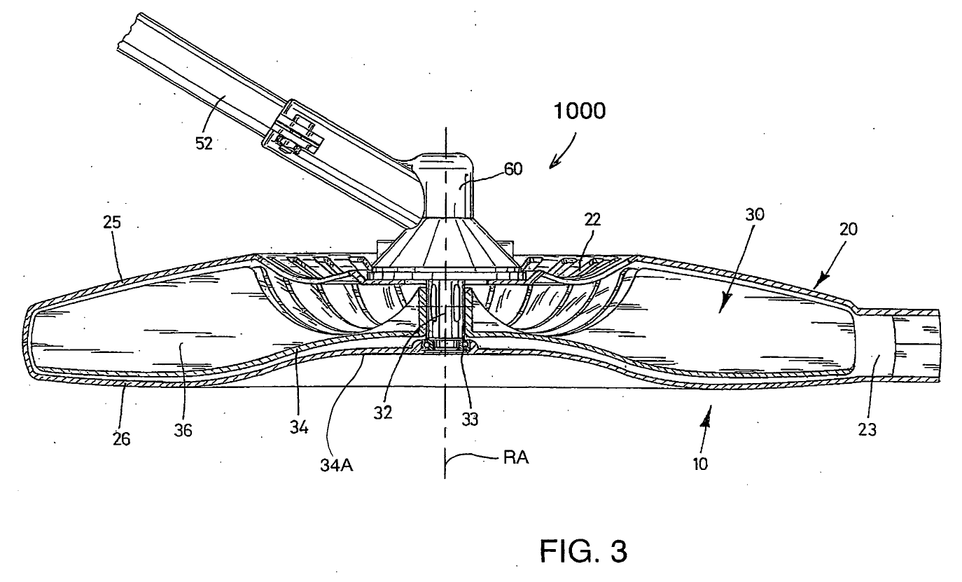

FIG. 3 shows a cross-section of a blower unit 1000 according to the invention, comprising the blower attachment 10 and the drive unit 50. The blower attachment 10 is attached to the drive unit 50 by means of a long drive shaft 52. The only part of the drive unit shown is the free end of the long drive shaft 52 with a drive head 60. The rotational axis of the drive head 60 is angled relative to the rotational axis of the drive shaft 52, by means of a ball joint or a gear. The impeller has a rotational axis RA. A directional change of the rotational axis of the drive unit 50 thus occurs in the drive head 60. The housing 20 of the blower attachment 10 shown in FIG. 3 has a cover 25 and a base 26. The air inlet 22, formed as a ring of air slots, is located in the cover 25. An impeller 30 is located inside the housing. The impeller 30 is constructed as a disk 34 on which impeller blades 36 are essentially arranged perpendicularly to the disk. The disk 34 of the impeller 30 has a curved cross-section, with a slight elevation 34A in the center. This construction of the impeller with the curved cross-section and elevation in the center is merely one embodiment. In another construction of the impeller, the top and bottom sides of the impeller can essentially be flat (except for the recess in the middle area), for example, to make production of the impeller more cost-effective. In the outer region, the impeller blades 36 almost completely fill the cross-section of the housing, so that only a small space exists between the internal wall of the housing 20 and the impeller 30. The impeller 30 has a center shaft 32 that is mounted on a bearing 33 in the housing 20 of the blower attachment 10. The shaft 32 of the impeller 30 is attachable to the drive head 60, such that the impeller 30 is rotatable by the long drive shaft 52. Due to the directional change in the drive head 60, the shaft 32 is at an angle to the drive shaft 52. As shown in other embodiments, it is not necessary to construct the impeller 30 with a shaft 32; rather, the impeller 30 may have a bore or a recess in the center, such that the drive shaft or the drive pin of a drive unit extends into this recess and causes the impeller 30 to rotate when this drive pin rotates.

For proper operation of the blower attachment 10, one sweeps the bottom of the housing 26 over the ground, so that the air that is drawn in from above through the inlet 22 and is expelled horizontally directly across the ground, so as to blow the debris on the ground.

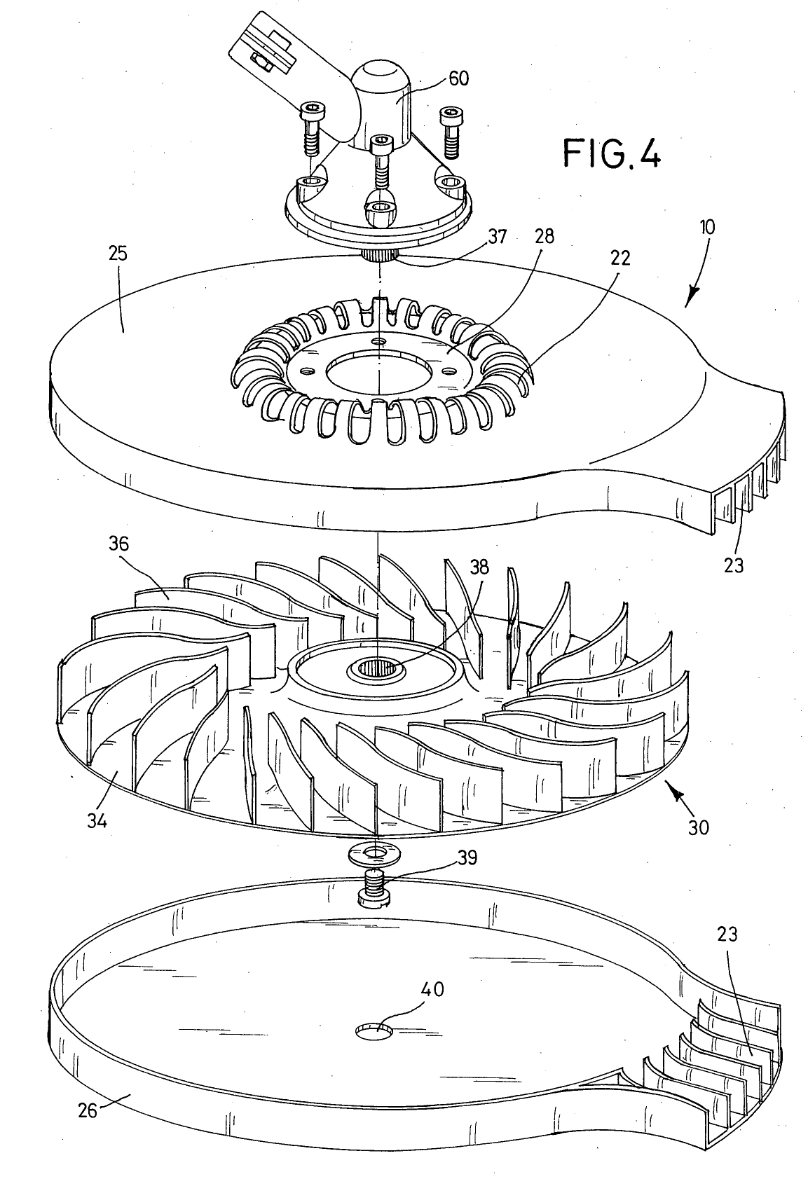

FIG. 4 shows an exploded view of the blower attachment 10 according to the invention. The air inlet 22 and the coupler 28 for the drive unit 50, as well as the top of the outlet 23, are located in the cover 25 of the housing 20. The impeller 30 is constructed as a single disk 34 on which the impeller blades 36 are arranged standing essentially perpendicular in the shape of a ring. The disk 34 of the impeller is elevated in the middle and reinforced, i.e., made of thicker material, in this center area, to provide good interference fit with the shaft, by means of which the impeller 30 is rotated. Of course, this embodiment is only one example; the impeller 30 may be constructed, for example, essentially flat or level on the top or bottom side.

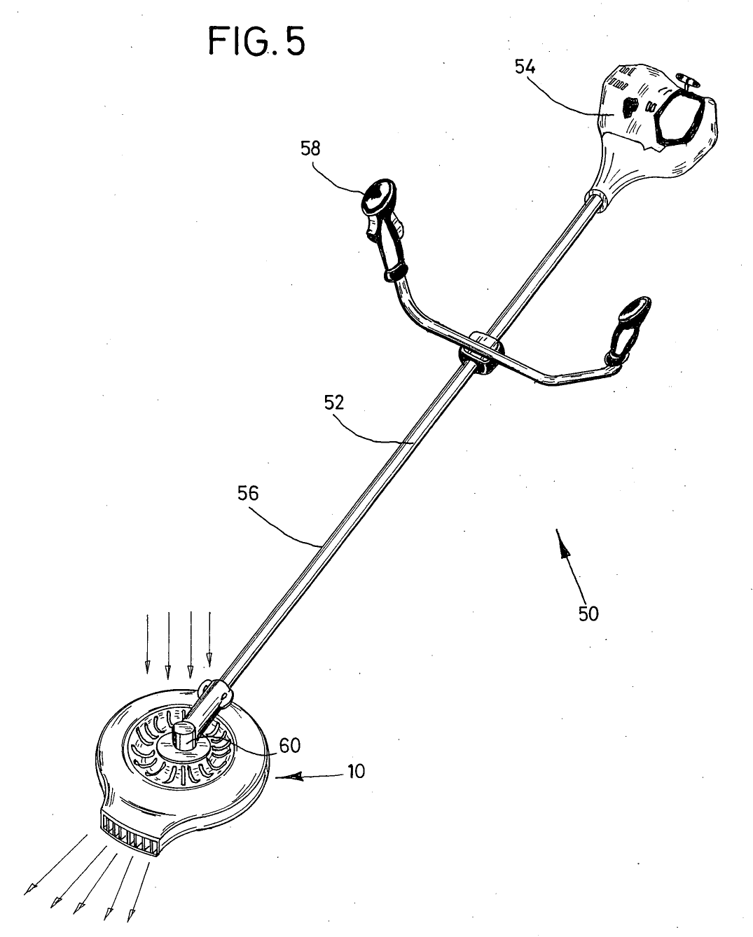

FIG. 5 shows a perspective view of the blower device according to the invention. The blower attachment 10 according to the invention is coupled to the drive unit 50, which has a long drive shaft 52. During operation, the air is drawn from above through the inlet 22 in the cover 25 of the housing 20 along the rotational axis RA of the impeller 30, and expelled horizontally over the ground perpendicular to the rotational axis 32 of the impeller 30. FIG. 5 clearly shows that, due to the long drive shaft 52, the motor 54 of the drive unit 50 and the blower attachment 10 are spaced far apart, so that the blower does not intensify the noise of the motor.

The desired advantages are achieved with the aforementioned innovation. The blower attachment 10 according to the invention is cost-effective to manufacture, since it does not contain a motor. For example, it can be made relatively inexpensively of plastic. Producing the attachment in plastic also results in a relative weight reduction, so that the blower attachment or the blower device is easy and comfortable to use. Coupling the attachment 10 to a drive unit 50 with a long drive shaft also has the advantage of spacing the blower and motor far apart. The long drive shaft 52 also expands the effective range of the blower device, so that the operator can reach even more remote or hard-to-reach spots with the blower attachment or the blower device. The invention makes it possible to use conventional drive units with a long drive shaft that are typically found in gardening and landscape maintenance as a blower.

The drive shaft 52 drives a splined drive pin 37, shown in FIG. 4, or the splined drive shaft, respectively, in rotational motion. When the blower attachment 10 is coupled to the drive unit, this drive pin 37 meshes into a central bore 38 of the impeller 30, causing the impeller to rotate. The impeller 30 is connected to the drive pin 37 by means of a screw 39 when the blower attachment 10 is coupled to the drive unit, i.e., the screw 39, which actually is a component of the drive unit, threads into a threaded opening provided in the drive pin 37.

The base 26 has an opening 40 through which the screw 39 can be threaded or unthreaded.

An adapter system can be used for a simple and inexpensive means of fastening of the blower attachment to the drive unit 50, whereby an adapter ring (not shown) is fastened to the side facing the blower attachment 10 and a corresponding construction of an adapter mating part is mounted on the cover 25 of the blower attachment 10. The blower attachment can then be fastened to the adapter ring that is attached to the drive head 60 by means of the adapter mating part affixed to it, for example, by screwing or locking, or by using a bayonet catch. The use of an adapter fastening system is advantageous, because it allows the blower attachment 10 to be very quickly removed from, or fastened to, the drive unit without, for example, requiring the use of a tool.

The adapter ring fastened to the drive head 60 corresponds in construction to that of the drive head 60, i.e., it can be constructed according to the various embodiments of the device, whereby only one embodiment of the adapter mating part provided on the cover 25 is required. Thus, particularly when a bayonet catch system is used between the adapter ring, on one side, and the adapter mating part, on the other, one can achieve both ease of operation and an inexpensive means of fastening the blower attachment 10 to the work device, especially if the adapter ring and adapter mating part are, for example, made of plastic. It is important that the use of an adapter enable one to attach the recommended blower device to all drive units, so that the recommended blower device may be used universally.

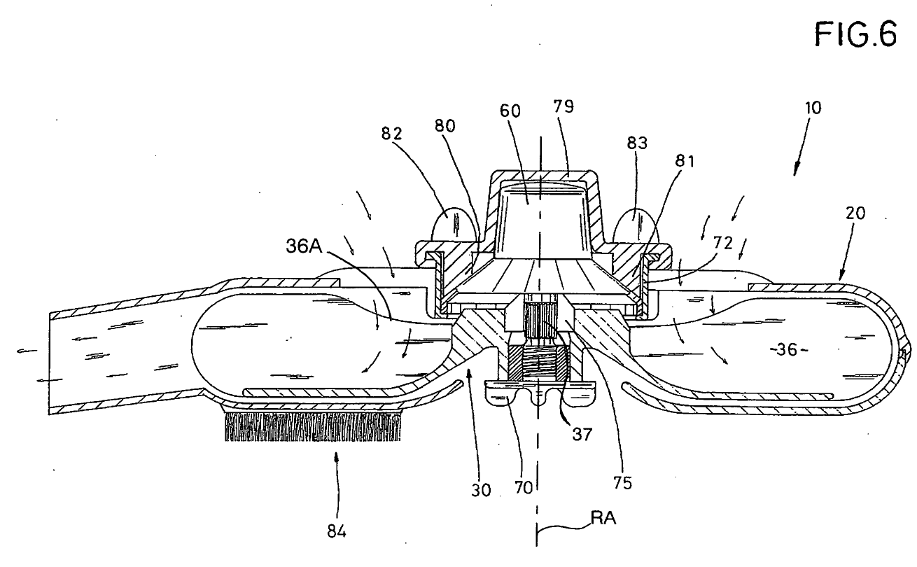

FIG. 6 shows another embodiment of the innovation that relates especially to the fastening of the blower attachment 10 to the drive head 60. In this embodiment, the drive pin 37 of the drive head 60 fits into a splined sleeve 75 of the blower attachment 10. This splined sleeve 75 corresponds in form to the external form of the drive pin 37, so that, when the drive pin 37 rotates, the splined sleeve 75 and the impeller blades arranged on it also begin to rotate. The impeller 30 is connected to the drive pin 37 by means of a wing nut 70 or other appropriate fastening device, whereby the wing nut 70 may be screwed into a threaded bore in the drive pin 37. This embodiment does not include an additional mounting of the impeller 30 in the region of the drive pin, in order to keep the production costs of the blowing attachment 10 as low as possible and the portion of blower attachment 10 parts that are made of plastic as high as possible, so that these parts can in turn be produced inexpensively. In this embodiment, the housing 20 of the blower attachment 10 is fastened to the drive head 60 via an adapter 72. In the embodiment shown, the adapter 72 grips the lower edge of the drive head 60. A fixing clamp 79 with two seating surfaces that rest on the top of the drive head when it is in the fixed position clamps the adapter 72 in place. The fixing clamp 79, which may also have a hood-shaped design, may be connected to the adapter 72, for example, by a threaded fastener or, as in this embodiment, a bayonet catch. The fixing clamp 79 is manually rotated to its fixed position, something easily done by using the raised grips 82, 83. This holds the adapter ring 72 on the housing 20 up against the drive head 60, whereby the fixing clamp 79 presses against and is supported by the drive head 60.

This therefore enables easy attachment of the blower attachment 10 to the drive head 60, as well as easy removal of the attachment from the drive head 60, without the need of a tool. The blower attachment 10 is adaptable to many different constructions of drive heads 60, by means of various embodiments of the adapter 72.

A brush 84 in the area of the outlet serves to loosen leaves that have been trodden into the ground, for example, which can then be picked up by the blowing airflow. The brush 84 also acts as a shock absorber for the blower attachment relative to the ground and prevents the blower attachment 10 from striking the ground too hard when improperly operated.

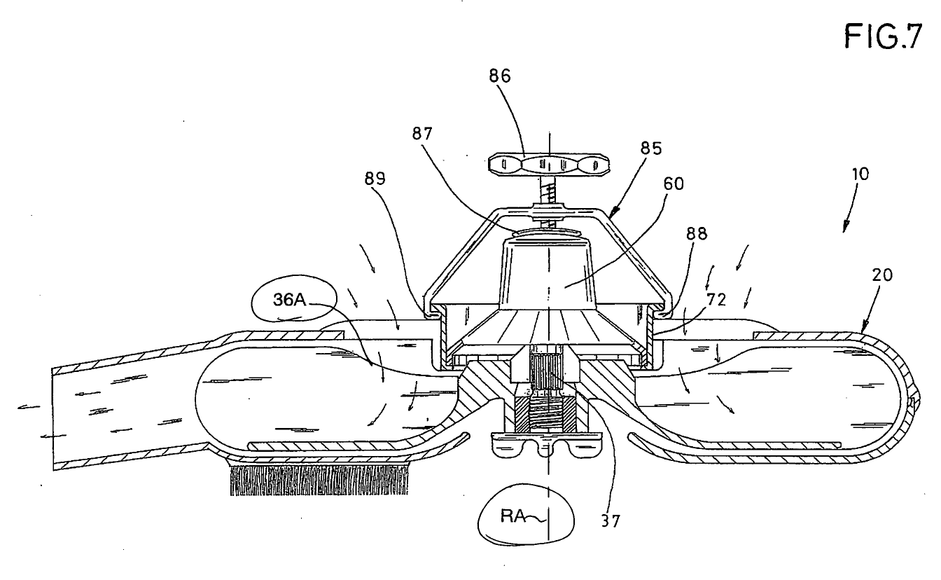

Another possible way of connecting the blower attachment 10 to the drive head 60 is to use a positioning part 85, as shown in FIG. 7, which can be affixed to the drive head 60 with a clamping device, for example, the tensioning screw 86. The tensioning screw is constructed to brace the top of the drive head 60 with a support plate 87. Like the fixing clamp 79, the positioning part 86 is another coupling mechanism for holding the drive head 60 and blower attachment 10 together.

With its two outriggers 88 and 89, the positioning part 85 engages the curved top edge of an adapter 72, which in turn is connected to the housing 20 of the blower attachment 10. Pressing the supporting plate onto the drive head allows the positioning part 85 to lock with the adapter 72 that is connected to the blower attachment 10. In this embodiment, the adapter 72 may also be adapted to the different measurements of the various constructions of drive heads 60. Again, only a positioning part is needed to attach different blower attachments to the corresponding drive heads 60. This embodiment also allows the positioning part 85 to be attached to the blower attachment 20, or to the adapter 72, respectively, for example, by turning via the use of a bayonet catch, as in the shown embodiment. Other suitable means of attachment may also be used.

This embodiment also avoids high production costs by simply fastening the impeller 30 to the drive pin 37, so that rotation of the drive pin 37 also rotates the impeller 30. No additional mounting is required in the area of the impeller blade; rather, the blower attachment housing is affixed by means of an external attachment aided by a positioning part 85. The external attachment is braced, on the one hand, against the housing wall of the drive head 60 and, on the other hand, is attachable to the housing of the blower attachment 10.

This embodiment also allows the blower attachment 10 to be fastened to the drive head 60 without use of a tool. Furthermore, this embodiment does not require that the drive head 60 of a conventional drive unit be altered. The operating noise of the blower attachment 10 is substantially reduced by lowering the top edge 36A of the impeller blades 36 in the area of the inflow air slot, as shown in FIGS. 6 and 7.

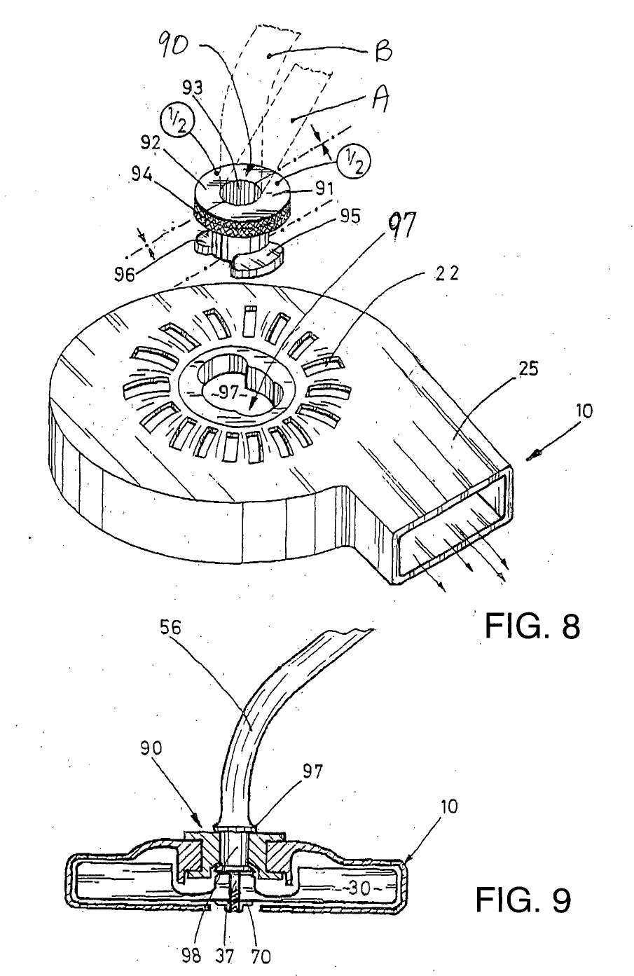

FIGS. 8 and 9A illustrate a further embodiment of the invention, in which a blower attachment 10 is attachable via an adapter 90 to a drive unit that is partially shown in FIG. 9. In this embodiment, the adapter 90 comprises two adapter shells 91, 92, which, when assembled as in FIG. 8, mate along fold lines 96 to form a sleeve or a continuous recess 93, which corresponds in length to the entire length of the adapter 90. As shown in FIG. 9, the continuous recess 93 formed by the adapter 90 is adapted to correspond to the outer diameter of the protective tube 56, within which the drive shaft of the drive unit extends.

The adapter 90, along with its adapter shells 91, 92, is thus attachable to the blower-attachment end of this protective tube 56, so that the protective tube is located inside the recess 93. The adapter 90 also has a projecting collar 94 on its upper side. The collar has a serrated edge, making it easy to operate or turn manually. Lock tabs 95, 96 are provided, spaced apart from the top of the adapter 90. The tabs are constructed to protrude laterally from the recess 93. Each adapter shell in this embodiment has a lock tab. The adapter 90 can be made of plastic or metal or any other suitable material. Of course, the adapter 90 can comprise more than the two adapter shells 91, 92 shown, which, as is shown in this embodiment, may be constructed as separate components. They may also be connected to each other with a hinge, for example, to provide particularly simple operation or handling.

The cover 25 of the housing of the blower attachment 10 has a contour 97 in the center, which essentially corresponds to the contour of the underside the adapter 90, i.e., the bottom contour of the adapter 90 together with the contour of the lock tabs 95 and 96, as well as of the central part of the adapter shells 91 and 92. With the adapter 90 positioned as shown in FIG. 8, the adapter 90 can now be lowered, so that the lock tabs 95, 96 protrude under the bottom of the cover 95. The adapter 90 can then be rotated 90 degrees, to move the lock tabs 95, 96 under the housing wall of the cover 25, thereby locking or affixing the adapter 90 with the cover 25. In this way, the adapter 90 allows the blower attachment 10 to be connected to the protective tube 56 of the drive unit.

The recess 93 is a continuous opening extending the entire length of the adapter 90. The drive pin 37, or, more generally, the drive axle of the drive unit, extends all the way through the adapter 90. When the adapter 90 is mounted, the drive pin or the drive shaft, respectively, extends through the housing of the blower attachment 10 and all the way through the impeller 30, which itself is driven by this drive shaft or the drive pin 37. The impeller is then connected to the drive shaft by means of a screw or other fastening element. For example, as shown in FIG. 6, a screw is guided through the impeller itself from the bottom of the impeller and screwed into a recess in the drive shaft. Thus, the impeller is screwed directly onto the drive shaft or drive axle and does not have an additional expensive mounting.

The blower attachment 10 that is mounted in this way is shown schematically in FIG. 9, along with the protective tube 56 of the drive shaft, the adapter 90, the motor-driven drive pin 37 or the end of the drive shaft, as well as a screw 70. Conventional drives A and B are schematically illustrated by dashed lines. In the case of the protective tube 56 shown in FIG. 9, within which the drive shaft extends, a special construction of this protective tube 56 is exploited in the blower-attachment area, in order to hold the adapter 90. The two adapter shells 91 and 92 encase the housing provided at the end of the protective tube 56 and allow the blower attachment 10 to attach to the adapter 90 without the use of additional locks, screws, or other lock means. The adapter 90 can, of course, be constructed such, that it may be used with all drive units 50 and the corresponding blower attachments 10.

The suggested adapter 90 is particularly advantageous in that it is individually adapted to any desirable drive unit, whereby the external perimeter of the adapter 90 always remains the same, so that the blower attachment 10 may have a uniform construction. While the external perimeter, or, external configuration of the adapter 90 always stays the same, the internal configuration of the adapter 90 must be adapted to the form of the respective drive housing or protective housing 56. This is achieved, for example, by the appropriate form of injection moulding dies.

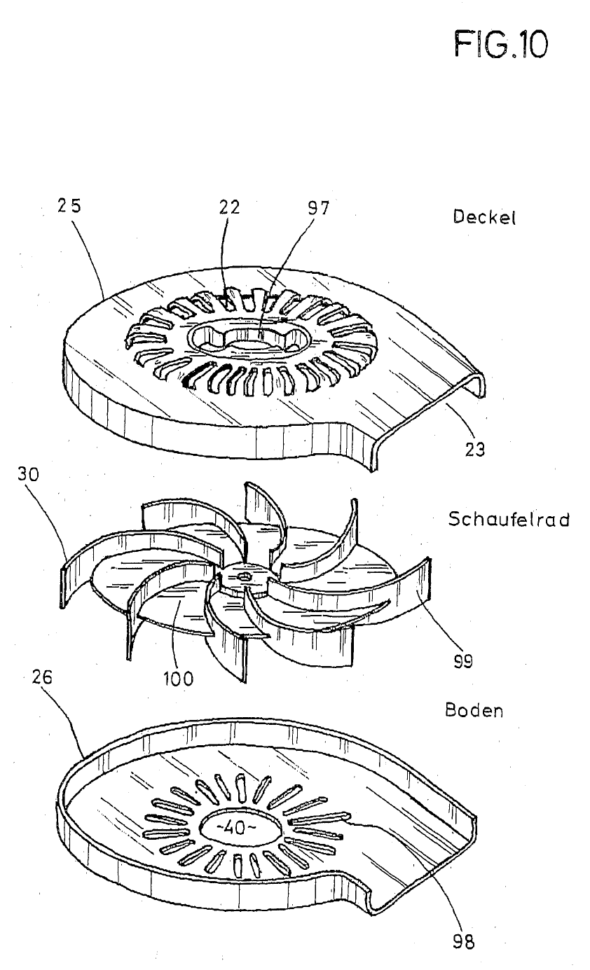

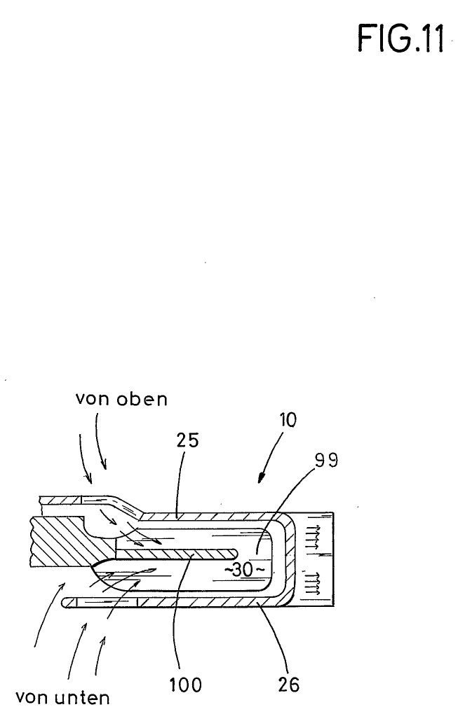

FIGS. 10 and 11 show another embodiment of the blower attachment, in which the blower attachment 10 again comprises a top cover 25 and a bottom cover or base 26, with an impeller 30 therebetween. Again, the top cover 25 has inlets 22 for the air, which, due to the rotation of the impeller 30, is expelled through the air outlet 23. In this embodiment, however, the base 26 also has air inlets 98, so that air from both the top and bottom of the blower attachment 10, i.e., through the air inlets of the top cover 25 and the base 26, is fed to the impeller 30, which is a two-sided construction in this embodiment. The individual air blades 99 are centrally positioned on an impeller base 100, i.e., they project beyond the impeller base 100, upward, in the direction of the top cover 25, and downward, toward the base 26. Such an arrangement allows air to be drawn simultaneously through the top cover 25 and the base 26, thereby achieving very high performance.

Protection against debris may be installed from underneath. For example, a filter may be provided in the area of the inlet slots 98 on the bottom; tests, however, have shown that the impeller 30 made of polyethylene, for example, is very robust, and no damage to the impeller was found. By introducing air from both above and below, an increase of approximately 20% in air speed at the outlet 23 was determined.

1-24. (canceled)

25. A blower attachment for a drive unit typically used in garden and landscape maintenance, said drive unit having a long drive shaft, said blower attachment comprising:
a housing having an air inlet and an air outlet; and
an impeller rotatable encased within said housing said impeller having a rotational axis;
wherein said housing is adapted to be couplable with said drive shaft of said drive unit;
wherein operation of said drive shaft causes a rotation of said impeller, which in turn effects an intake of air through said air inlet and an exhaust of air through said air outlet.

26. The blower attachment of claim 25, wherein said impeller has a center shaft for coupling said impeller with said drive unit.

27. The blower attachment of claim 25, wherein said impeller has an air discharge edge, wherein said housing includes a cover having a top wall and a side wall, and wherein said air inlet is provided in said top wall above said impeller and said air outlet is provided in said side wall lateral said air discharge edge.

28. The blower attachment of claim 27, wherein said air inlet includes an annular arrangement of apertures placed radially about said rotational axis.

29. The blower attachment of claim 27, wherein said air outlet is provided as a single discharge opening extending across a portion of said side wall.

30. The blower attachment of claim 27, wherein said housing further includes a coupler incorporated into said cover, said coupler adapted to couple said housing with said drive shaft of said drive unit.

31. The blower attachment of claim 25, wherein said impeller comprises a disk and a plurality of impeller blades, each one of said impeller blades having an impeller face, and wherein said impeller blades are arranged radially about said impeller rotational axis, with said impeller face perpendicular to said disk.

32. The blower attachment of claim 31, said impeller having an intake section, and wherein, by rotation of said impeller, air is drawn through said air inlet into said impeller at said intake section and expelled through said air outlet.

33. The blower attachment of claim 32, wherein said each one of said impeller blades has a cut-away section at said intake section of said impeller.

34. The blower attachment of claim 31, wherein said disk has a central portion that is raised relative to an outer perimeter of said disk.

35. The blower attachment of claim 31, wherein said disk has an upper surface and a lower surface and each one of said impeller blades has an impeller face with a height dimension, and wherein said plurality of impeller blades are mounted on said disk, such that a first portion of said height dimension of said impeller face extends upward of said first surface and a second portion of said height dimension extends downward of said second surface of said disk.

36. The blower attachment of claim 35, wherein said housing includes a top cover and a bottom cover, said top cover having at least one air inlet.

37. The blower attachment of claim 36, said bottom cover having at least one air inlet.

38. The blower attachment of claim 25, wherein said impeller includes a female connector for receiving a drive pin of said drive shaft.

39. The blower attachment of claim 38, wherein said impeller is mountable within said housing by means of a coupling between said female connector and said drive pin.

40. The blower attachment of claim 25 further comprising a brush that is mounted on an underside of said housing.

41. A blower unit comprising:
a blower attachment having a housing, an air inlet, an air outlet, an impeller, and a coupler, said impeller having a rotational axis and encased within said housing, and said air inlet and said air outlet provided on said housing;
a drive unit having a drive shaft; and
a coupler for detachably coupling said blower attachment to said drive unit.

42. The blower unit of claim 41, wherein said drive unit has a drive head at an operating end of said drive shaft, and wherein said coupler includes a splined shaft that extends from said drive head, said splined shaft having a threaded bore, a splined bore in said impeller for receiving said splined shaft, and a threaded fastener that is threadable into said splined shaft for drivably coupling said blower attachment to said drive head.

43. The blower unit of claim 41, wherein said coupler comprises an adapter that is attachable to said drive shaft and wherein said blower attachment includes an adapter retainer recess for receiving said adapter, such that, when said adapter is attached to said drive shaft and secured in said blower attachment, operation of said drive unit causes said impeller to rotate.

44. The blower unit of claim 43, wherein said adapter includes a splined drive pin coupled with said drive shaft, and a splined sleeve provided in said blower attachment for receiving said splined drive pin, and a threaded fastener, said splined sleeve having a lower end with threaded internal bore into which said threaded fastener is securable, so as to fasten said blower attachment to said drive unit.

45. The blower unit of claim 43, wherein said adapter includes a sleeve that is adapted to fit around an end of said drive shaft and an adapter base; and wherein said blower attachment has an adapter retainer recess for receiving and locking said adapter base with said end of drive shaft securely within said blower attachment.

46. The blower unit of claim 41, wherein said drive unit has a drive head at an operating end of said drive shaft, and wherein said coupler includes an adapter ring that seats said drive head within said blower attachment and a fixing clamp that lockingly engages with said adapter ring to hold said drive head coupled with said blower attachment.

47. The blower unit of claim 41, wherein said drive unit is a motorized lawn trimmer generally used to operate a cutting tool, with said cutting tool removed, and said blower attachment is coupled to said drive shaft of said drive unit.
